(19) United States
(12) Patent Application Publication
(10) Pub. No.: US 2021/0282230 A1
(43) Pub. Date: Sep. 9, 2021

(54) CORE ROUTER FOR A MULTI-PURPOSE CELLULAR NETWORK WITH 5G PROXY FUNCTIONALITIES

(71) Applicant: Geoverse, LLC, Bellevue, WA (US)

(72) Inventor: Roderick Nelson, Sammamish, WA (US)

(21) Appl. No.: 17/193,642

(22) Filed: Mar. 5, 2021

Related U.S. Application Data
(60) Provisional application No. 62/985,469, filed on Mar. 5, 2020.

(51) Int. Cl. H04W 88/16; H04W 88/18; H04W 40/24; H04W 28/02; H04W 84/04; H04W 76/12; H04W 76/16

(52) U.S. Cl. CPC H04W 88/16; H04W 88/182; H04W 40/24; H04W 76/16; H04W 84/045; H04W 76/12; H04W 28/0268

(57) ABSTRACT

A management system of a multi-purpose cellular network provides a scalable 5G connectivity to endpoints of multiple private cellular networks and/or public mobile network operators. The management system includes a first interface for communicating with a 5G base station; a second for communicating with a 4G base station and third interface for communicating with an external network operator to obtain a service level agreement for operation of an endpoint of the external network on the multi-purpose cellular network. The communication between the endpoint and 5G core network of the external network may be established via the first interface for both data and control signaling traffic while the communication between the endpoint and a 4G core network of the external network may be established via the first interface for data traffic and via the second interface to an eNB of the external network.

### CROSS-REFERENCE TO RELATED APPLICATIONS

This application claims priority to U.S. Provisional Patent Application No. 62/985,469 filed on Mar. 5, 2020, the entire content of each of which is incorporated herein by reference.

### BACKGROUND

### Field of the Disclosure

The present disclosure relates to operation of a multi-purpose cellular network comprising both public and private network fifth generation capabilities and more specifically to interoperability of a multi-purpose cellular network with multiple external networks using a Fifth Generation (5G) proxy router.

### Description of the Related Art

Various generations of wireless technologies and supporting networks have been designed, standardized, implemented and used globally to service millions/billions of end users. These wireless networks have evolved from analog to digital radio access systems, from circuit switching to packet core, from proprietary mobility and administrative protocols to standardized protocols, and from single provider to multi provider networks.

As wireless technologies evolve and connectivity capabilities of mobile devices and Internet of Things (IoT) devices increase, many established and large cellular wireless service providers (mobile network operators) are unable to meet the increased demand efficiently. To meet this demand, cellular networks have evolved through various generations of technology, with multiple portions of the radio spectrum have been converted for use by cellular networks. As capacity demands increase, more and more cellular base stations are deployed that operate at higher frequency radio spectrum, thus decreasing the area covered by an individual base station. In addition, the use of cellular networks for private networks augmenting enterprise technologies such as WiFi creates even more demand for deployment of cellular network equipment. The result of these trends is the need to share more and more equipment amongst multiple network operators.

### SUMMARY

One or more example embodiments of inventive concepts are directed to multi-purpose cellular networks that provide cellular connectivity at one or more geographical locations to devices (endpoints) associated with one or more private cellular networks and/or one or more public mobile network operators. A core router (may alternatively be referred to as edge core router, a proxy router, and/or edge core proxy router) of example multi-purpose cellular networks of the present disclosure can include 5G proxy functionalities to enable, monitor and manage communication of the devices (both private and public devices) connected to the multi-purpose cellular network. More specifically, such core router can allow for a scalable sharing of 5G spectrum of the multi-purpose cellular network by connected endpoints of multiple private/MNO networks and can allow for interfacing a single (or a few) gNBs to multiple Fifth Generation (5G) core networks and/or e-NodeBs of Fourth Generation (4G)/Long-Term Evolution (LTE) networks for transmission of user and control signaling data. Furthermore, the core router described herein can monitor and enforce respective Service Level Agreements (SLAs) in place between the operator of multi-purpose cellular network and operator(s) of private cellular/MNO networks users of which may access 5G resources of the multi-purpose cellular network.

In one aspect, a management system of a multi-purpose cellular network includes a first interface configured to communicatively couple with at least one fifth-generation (5G) base station of the multi-purpose cellular network; a second interface configured to communicatively couple with at least one fourth-generation (4G) base station of at least one external network operator; a third interface configured to communicatively couple with the at least one external network operator; at least one memory having computer-readable instructions stored therein; and one or more processors. The one or more processors are configured to execute the computer-readable instructions to receive a connection request for an endpoint to connect to the multi-purpose cellular network, the endpoint being associated with one of the at least one external network operator, wherein a core network of each external network operator is one of a fourth generation (4G) core network or a fifth generation (5G) core network; establish a network connection for the endpoint to operate on the multi-purpose cellular network based on a service level agreement between a corresponding external network operator of the endpoint and the multi-purpose cellular network obtained via the third interface; and manage the network connection for the endpoint, wherein managing the network connection includes routing network traffic for the endpoint, to: (1) a 4G core network of the corresponding external network operator via the first interface for user traffic and via the second interface for control signals, if the core network of the corresponding external network is a 4G core network; or (2) a 5G core network of the corresponding external network operator via the first interface, if the core network of the corresponding external network is a 5G core network.

In another aspect, the first interface is a New Generation (NG) interface.

In another aspect, the second interface is an X2 interface.

In another aspect, the management system includes a core router including the first interface and the second interface, the core router being installed at a site component of the multi-purpose cellular network.

In another aspect, the core router is configured to simultaneously manage spectrum sharing of a plurality of endpoints on the multi-purpose cellular network according to respective service level agreements for each of the plurality of endpoints and establish communicating to respective core networks of the plurality of endpoints for transmission of user traffic and control signal using at least one of the first interface and the second interface, at least one core network of the core networks being the 4G core network and at least one core network of the core networks being a 5G core network.

In another aspect, the management system includes a cloud based component comprising the third interface that is communicatively coupled to a service management and orchestration component of the corresponding external network operator of the endpoint to generate, record and implement the service level agreement.

In another aspect, the at least one external network operator is an operator of a private cellular network having the 4G core network or the 5G core network, or an operator of a public mobile network having the 4G core network or the 5G core network.

In another aspect, the one or more processors are configured to execute the computer-readable instructions to configure a radio access network of the multi-purpose cellular network to be shared by a plurality of endpoints by partitioning a spectrum of the radio access network into virtual slices, each virtual slice of the virtual slices being assigned to one of the plurality of endpoints.

In another aspect, the service level agreement indicates a level of wireless connectivity available to the endpoint when connected to the multi-purpose cellular network.

In another aspect, managing the network connection is further includes measuring Key Performance Indicators (KPIs) associated with operation of the endpoint on the multi-purpose cellular network, the KPIs including at least one of a Quality of Service (QoS) of a connection between the endpoint and the multi-purpose cellular network, data download/upload rate, and packet drop rate.

In one aspect, one or more non-transitory computer-readable media include computer-readable instructions, which when executed by one or more processors of a management system of a multi-purpose cellular network, cause the management system to receive a connection request for an endpoint to connect to the multi-purpose cellular network, the endpoint being associated with at least one external network operator, wherein a core network of the external network operator associated with the endpoint is one of a fourth generation (4G) core network or a fifth generation (5G) core network, the management system including a first interface configured to communicatively couple with at least one fifth-generation (5G) base station of the multi-purpose cellular network, a second interface configured to communicatively couple with at least one fourth-generation (4G) base station of the at least one external network operator, and a third interface configured to communicatively couple with the at least one external network operator; establish a network connection for the endpoint to operate on the multi-purpose cellular network based on a service level agreement between a corresponding external network operator of the endpoint and the multi-purpose cellular network obtained via the third interface; and manage the network connection for the endpoint, wherein managing the network connection includes at least routing network traffic for the endpoint to: (1) a 4G core network of the corresponding external network operator via the first interface for user traffic and via the second interface for control signals, if the core network of the corresponding external network is a 4G core network; or (2) a 5G core network of the corresponding external network operator via the first interface, if the core network of the corresponding external network is a 5G core network.

In one aspect, a method of managing a multi-purpose cellular network includes receiving, at a management system of the multi-purpose cellular network, a connection request for an endpoint to connect to the multi-purpose cellular network, the endpoint being associated with at least one external network operator, wherein a core network of the external network operator associated with the endpoint is one of a fourth generation (4G) core network or a fifth generation (5G) core network, the management system including a first interface configured to communicatively couple with at least one fifth-generation (5G) base station of the multi-purpose cellular network, a second interface configured to communicatively couple with at least one fourth-generation (4G) base station of the at least one external network operator, and a third interface configured to communicatively couple with the at least one external network operator; establishing a network connection for the endpoint to operate on the multi-purpose cellular network based on a service level agreement between a corresponding external network operator of the endpoint and the multi-purpose cellular network obtained via the third interface; and managing the network connection for the endpoint, wherein managing the network connection includes at least routing network traffic for the endpoint to: (1) a 4G core network of the corresponding external network operator via the first interface for user traffic and via the second interface for control signals, if the core network of the corresponding external network is a 4G core network; or (2) a 5G core network of the corresponding external network operator via the first interface, if the core network of the corresponding external network is a 5G core network.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an overview of a cellular network ecosystem, according to an aspect of the present disclosure;

FIG. 2 illustrates an overview of a site component of a multi-purpose cellular network of FIG. 1 deployed at an edge site, according to an aspect of the present disclosure;

FIG. 3 is a visual representation of an architecture of a multi-purpose cellular network interconnected with multiple 5G core networks, according to an aspect of the present disclosure;

FIG. 4 is a visual representation of an architecture of a multi-purpose cellular network interconnected with multiple 4G/LTE networks, according to an aspect of the present disclosure;

FIG. 5 is a flowchart of a method of operation of core router of multi-purpose cellular network of FIGS. 3 and 4, according to an aspect of the present disclosure; and

FIGS. 6A and 6B illustrate systems, according to an aspect of the present disclosure.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

A multi-purpose cellular network within the context of the present disclosure is a system comprised of a backend component (a cloud component) and one or more site components. A site component may be comprised of specially configured hardware components installed at a site to provide cellular network (voice and data) connectivity to endpoints connected thereto.

A site component can be comprised of a number (e.g., ranging from single digit numbers to hundreds or thousands) of radio access components (e.g., radio components that provide network connectivity such as LTE and 5G access nodes, etc.) that may be deployed over a geographical area (e.g., a building, a factory floor, a neighborhood, a shopping mall, etc.) and operate over a spectrum available for cellular use (e.g., 5G). Furthermore, the site component can optionally include known or to be developed radio equipment such as routers and core network components (e.g., 5G core network (5GCN) components).

For example, a 5GCN components include, but are not limited to, a Authentication Server Function (AUSF), a Core Access and Mobility Management Function (AMF), a Data network (DN), a Structured Data Storage network function (SDSF), an Unstructured Data Storage network function (UDSF), a Network Exposure Function (NEF), a NF Repository Function (NRF), a Policy Control function (PCF), a Session Management Function (SMF), a Unified Data Management (UDM), a User plane Function (UPF), an Application Function (AF), etc. Components of a 5G core can be referred to as functionalities as most are software based and can be adapted according to need and use case.

The site component can also include IP Multimedia Subsystem (IMS) for delivering IP multimedia services such as Voice over LTE (Vo-LTE) through IMS core. IMS core can handle IMS functionalities including, but not limited to, subscriber management, session setup and policy and charging enforcement, maintaining Quality of Service (QoS) and seamless interfacing between IMS Application Servers and the EPC.

The backend (cloud) component may provide one or more Evolved Packet Core (EPC) and 5GCN functionalities (e.g., HSS services), manage interfacing and communication of the private cellular network with MNOs, allow mobility among users of the private network (e.g., an enterprise network) by enabling them to move between multiple site components of the multi-purpose cellular network that may be installed at different locations associated with the enterprise network and still access their home site component, etc. Services provided by the backend component may also include centralized radio access network functionalities, service management functionalities for generating, recording and implementing service level agreements with partnered private cellular and/or MNO networks, etc. Furthermore, resources of such backend component may be shared by/segmented for use by multiple private cellular networks and/or multiple public cellular network providers. Additionally, the backend component may include networking and management tools (Network as a Service (NaaS)) built and deployed over network components (that are trusted by operators of the private cellular networks and various mobile network operators (MNOs)) to manage access by subscribers of different private cellular networks or MNOs to the multi-purpose cellular network. As will be described below, such private cellular networks and/or MNOs may have suboptimal coverage in geographical locations where such multi-purpose cellular networks provide cellular coverage and therefore can have their endpoints and subscribers connect to a site component of a multi-purpose cellular network and obtain cellular network connectivity through the multi-purpose cellular network.

Such systems, as described above, offer a fully interconnected multi-purpose cellular network with a number of significant advantages to enterprises and MNOs. These systems are flexible and scalable and eliminate costs and complexities associated with enterprises having to develop their own private network capabilities and/or costs and complexities associated with MNOs having to deploy their own separate network infrastructure and services to provide cellular connectivity to their subscribers and endpoints.

A fully integrated system described above provides premium connectivity services to users of both private networks and the users of multiple public network operators coupled with various analytical features such as end user experience, service usages, indoor location determination and indoor mapping, integration of multiple radio spectrum bands, and coordination of multiple independent service level agreements.

Premium connectivity services include, but are not limited to, Subscriber Identity Module (SIM) subscriptions, shared data bundles, private cellular (LTE) voice, edge computing capabilities, etc. Private and public network devices include, but are not limited to, bridges, gateways, modems, push-to-talk devices, smartphones, tablets, laptops, Internet of Things (IoT) devices such as facility management devices, HVAC control devices, security monitoring devices, point of sale devices, sensors for maintenance, asset tracking, etc., robotics and autonomous vehicles, etc.

In one or more examples described below, multi-purpose cellular network of the present disclosure may provide 5G connectivity to endpoints connected thereto in two modes of operation. The first mode of operation is referred to as Non-Standalone (NSA) mode to accommodate transition of mobile network operators from existing 4G/LTE infrastructure to fully 5G network, wherein the 5G radio interface is used only for user traffic but all control signaling is handled by a co-existing 4G LTE network. The second mode of operation is referred to as Standalone (SA) mode utilized by 5G mobile operators. In SA, the control and user plane traffic are handled all with in the 5G network domain without reliance on a co-existing 4G LTE network. The present multi-purpose cellular network enables sharing of 5G radio resources in both the non-standalone and standalone modes by endpoints of multiple private cellular networks and/or MNOs.

With respect to 5G radio resource sharing, example multi-purpose cellular network of the present disclosure provides a scalable 5G proxy functionality, implemented at a core router of the multi-purpose cellular network, for multiplexing network traffic from a single 5G base station (e.g., a single gNB) to core networks of multiple 4G/LTE and 5G network operators, the respective users of which may be connected to and operating on the multi-purpose cellular network. Furthermore, the 5G proxy functionalities enable endpoints having dual 4G/5G radio interfaces to utilize the 5G radio band and the gNB for user traffic and data communication while control signals may be exchanged with the e-NodeB/4G EPC of such devices, as will be described below. 5G proxy functionalities of a core router of the multi-purpose cellular network further allows for monitoring and management of Service Level Agreements (SLAs), agreed to and recorded using a centralized management component of the multi-purpose cellular network between the operator of the multi-purpose cellular network and home networks of endpoints operating on the multi-purpose cellular network. These and other advantages of the 5G proxy functionality will be further described below.

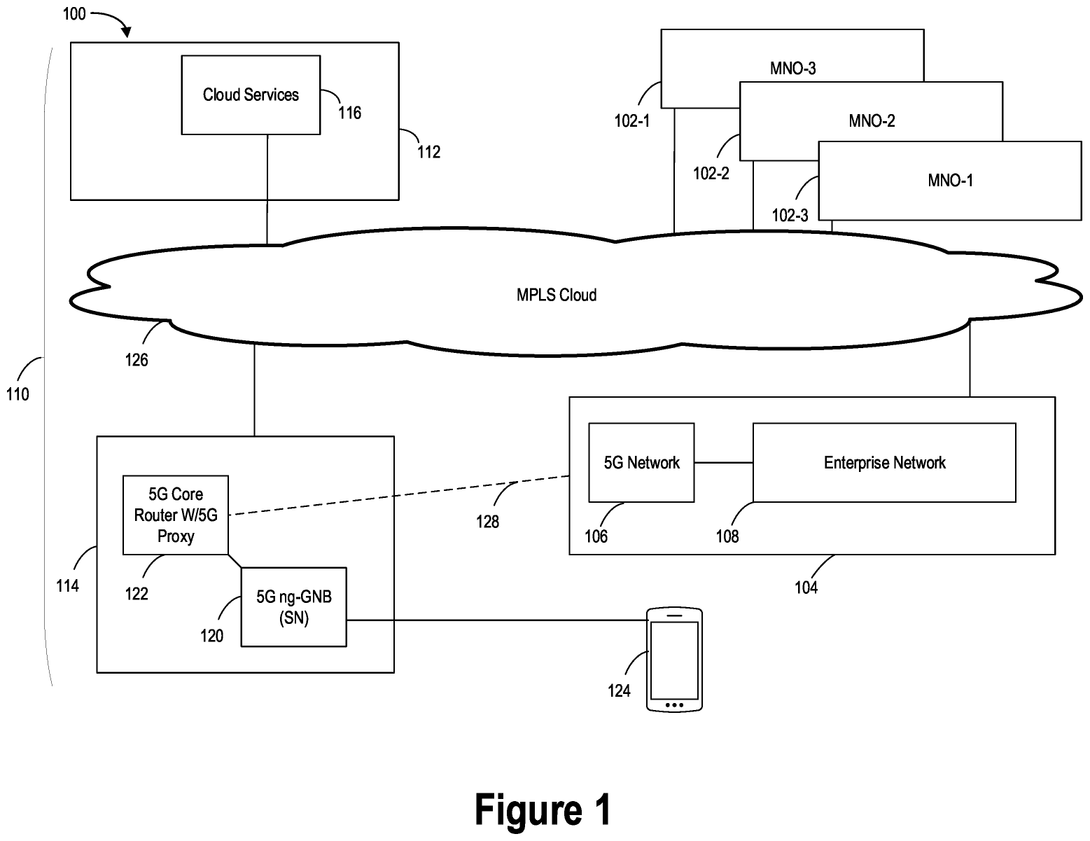

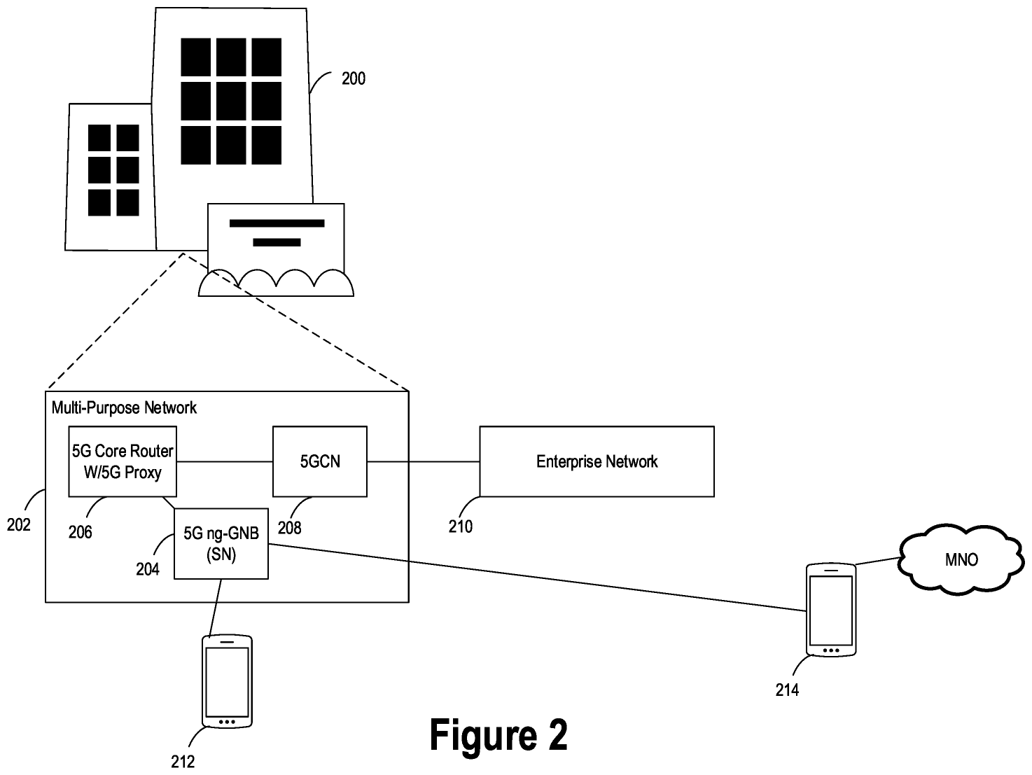

First several example implementations of a private cellular network system will be described with reference to FIGS. 1 and 2.

FIG. 1 illustrates an overview of a cellular network ecosystem, according to an aspect of the present disclosure. In ecosystem 100, one or more Mobile Network Operators (MNOs) 102. In example of FIG. 1, three MNOs 102-1, 102-2, and 102-3 are shown. However, the number of MNOs that may be part of ecosystem 100 are not limited to the three shown in FIG. 1 but may be more or less.

MNOs 102 may include, but are not limited to, known operators of cellular networks such as AT&T®, Verizon®, T-Mobile®, Sprint®, Charter Spectrum®, Xfinity Mobile®, Vodafone® and/or any other known or to be established MNO. In one example, MNOs 102 may have a number of subscribers that may connect to a site component of a multi-purpose cellular network, described below. These subscribers may utilize the multi-purpose cellular network based on an agreement in place between their home network provide (e.g., one of MNOs 102) and an operator of the multi-purpose cellular network.

Ecosystem 100 may further include a private cellular network 104. The number of private cellular networks in ecosystem 100 is not limited to one but may be more or less. Private cellular network 104 may include a standalone/independent 4G/LTE and/or 5G cellular network. Such private cellular network 104 may be configured to provide cellular connectivity within a defined geographical area (e.g., a building, a campus, a neighborhood, a shopping mall, one or more floors within a building, etc.). For example, an institution may have the private cellular network 104 deployed at one or more of its locations. Various components and functionalities of a private cellular network have been described in U.S. application Ser. No. 16/940,739 filed on Jul. 28, 2020 and titled “SYSTEMS AND METHODS FOR MONITORING AND MANAGING NETWORK TRAFFIC IN A PRIVATE CELLULAR NETWORK”, the content of which is incorporated herein, in its entirety).

As shown in FIG. 1, private cellular network 104 may include, among other known or to be developed components, a 5G network 106 and an enterprise network 108. The 5G network 106 may include any number of known or to be developed components of a fully integrated/autonomous 5G network (e.g., local edge components such as an access point, an edge proxy router, an edge core network, and cloud based components for communication with external services such as MNOs, emergency services, etc.). Various components and functionalities of a private cellular network such as 5G network 106 have been described in U.S. application Ser. No. 16/940,739 filed on Jul. 28, 2020 and titled “SYSTEMS AND METHODS FOR MONITORING AND MANAGING NETWORK TRAFFIC IN A PRIVATE CELLULAR NETWORK”, the content of which is incorporated herein, in its entirety).

Alternatively and instead of relying on a dedicated set of edge components such as an access point and an edge proxy router, 5G network 106 may include an edge core network (e.g., a 5G Core Network (5GCN)) that is coupled to 5G core router and gNB of the multi-purpose network 110.

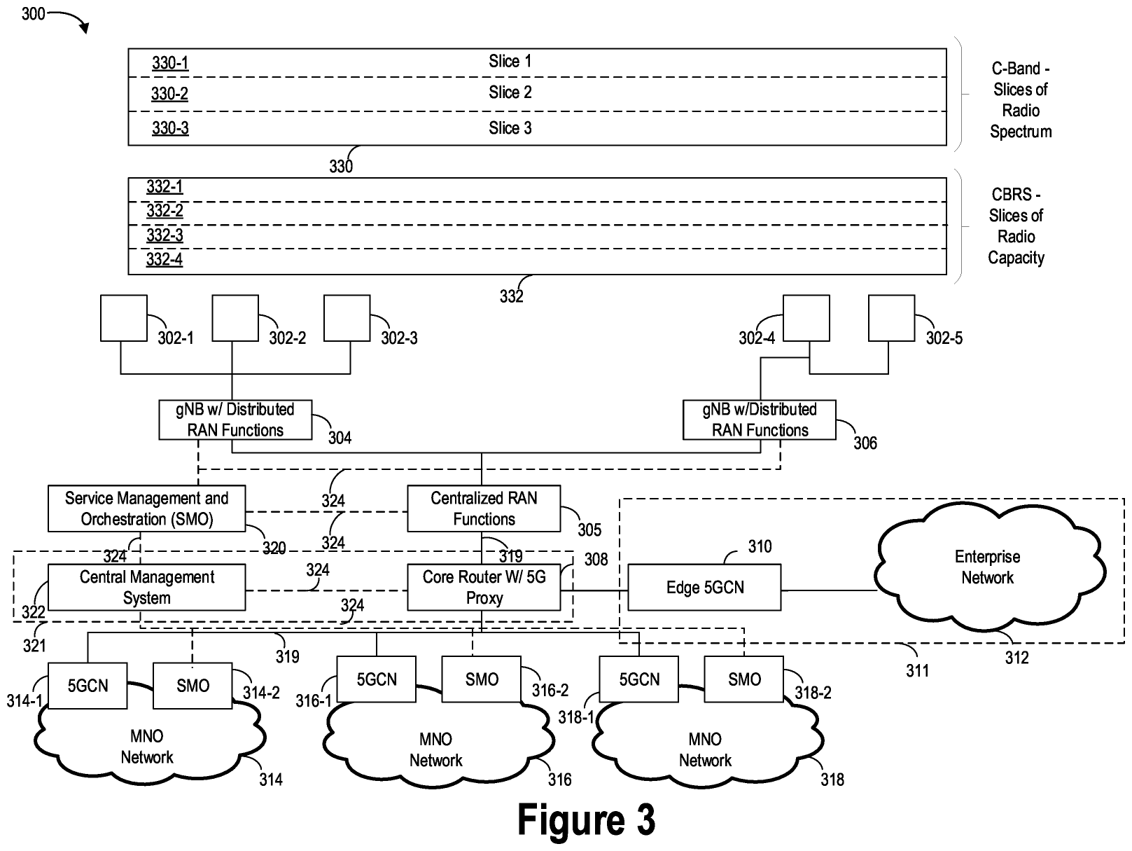

Ecosystem 100 may further include a multi-purpose cellular network 110. Multi-purpose cellular network 110 may be comprised of a cloud based backend component 112 and one or more site components such as site component 114. The cloud based backend component 112 may include cloud services 116, various components/functionalities of which will be further described below with reference to FIG. 3.

Site component 114 may include one or more 5G base stations (e.g., gNB) 120, a 5G core router 122 and/or any other known or to be developed component. As will be described below, gNB 120 may be referred to as a Support Node or Slave Node (SN). While FIG. 1 illustrates a single site component 114 of multi-purpose cellular network 110, the present disclosure is not limited thereto. The multi-purpose cellular network 110 may have a number of site components deployed at various locations to which user devices (endpoints) may connect.

One or more endpoints 124 may connect to multi-purpose cellular network 110 via gNB 120 at site component 114. Such endpoint 124 may be any one of a tablet, a mobile device, a laptop, an Internet of Things (IoT) device, an electric charger, etc. Endpoint 124 may belong to any one of MNOs 102 or private cellular network 104. A number of endpoints connected to the multi-purpose cellular network is not limited to one as shown in FIG. 1 and may be more or less. Multipe endpoints connected to multi-purpose cellular network 110 may be associated with private cellular network 104 or any one or more of MNOs 102. Private cellular network 104 and/or MNOs 102 may be a 4G/LTE or a 5G network having a corresponding 4G/LTE or 5G core network. Connectivity of endpoint 124 to gNB 120 may be automatic (e.g., in 5G SA mode or may be upon receiving a triggering control signal from a home e-NodeB in NSA mode, both of which will be further described below).

While the ecosystem 100 of FIG. 1 has been described in which multi-purpose cellular network 110 may be utilized as a “backup” network for endpoints of MNOs 102 and/or private cellular network 104 (e.g., endpoint 124) in an “opportunistic” manner, the present disclosure is not limited to such use of multi-purpose cellular network 110. For example, multi-purpose cellular network 110 may be a permanent fixture of the network infrastructure of any one of MNOs 102 and/or private cellular network 104 to allow sharing of 5G resources of the corresponding network in 5G SA and NSA modes by 5G and/or 4G/LTE users of the same network or with multiple additional 5GCNs and/or 4G/LTE Evolved Packet Cores (EPCs) of other operators, users of which may be operating on the MNO network of which the multi-purpose cellular network 110 is a permanent fixture. Similarly, the multi-purpose cellular network 110 may be a permanent fixture of a private cellular network such as the private cellular network 104.

As shown in FIG. 1, cloud based backend component 112 of multi-purpose cellular network 110 may be communicatively coupled to site component 118 via Multi-Protocol Label Switching (MPLS) cloud 126 on which one or more EPCs or 5GCNs 110 of the multi-purpose cellular network (e.g., located in different physical locations/cities) are accessible. Similarly, communications between multi-purpose cellular network 110 and various MNOs and/or private cellular network 104 may be through MPLS cloud 126 or may alternatively be a direct connection via dashed connection line 128 shown in FIG. 1.

FIG. 2 illustrates an overview of a site component of a multi-purpose cellular network of FIG. 1 deployed at an edge site, according to an aspect of the present disclosure. Edge site 200 of FIG. 2 may be a building or a portion of a building in which site component 202 of a multi-purpose cellular network such as multi-purpose cellular network 110 may be installed. Edge site component 202 may be the same as site component 114 and similarly 5G gNB 204 and edge 5G core router 206 may be the same as 5G gNB 120 and core router 122 of FIG. 1, respectively. In comparison with FIG. 1, the system setup of FIG. 2 is such that the multi-purpose network and more specifically site component 202 thereof may be incorporated into a private cellular network installed at edge site 200. Accordingly and in contrast to FIG. 1, 5GCN 208 is part of the site component 202. At edge site 200, there may also be an enterprise network 210 that can be the same as enterprise network 108 of FIG. 1. FIG. 2 further illustrates an endpoint 212. Endpoint 212 may be associated with enterprise network 210 or an institution/organization (e.g., endpoint 212 may be registered with enterprise network 210 and assigned to an employee of the institution/organization) at which enterprise network 210 and site component 202 of the private cellular network is deployed. Accordingly, endpoint 212 may be a home device for which the private cellular network at edge site 200 (also functioning as a multi-purpose cellular network 110) serves as a home network. At the same time, the private cellular network at edge site 200 may also provide roaming services to one or more visiting/guest endpoints such as endpoint 214.

In one instance, endpoint 214 has a 5G radio interface and its home network is a 5G network with a corresponding 5GCN, both user and control signaling traffic may be carried over endpoint 214's 5G radio interface and communicated to 5GCN of the home network of endpoint 214 via 5G core router 206 (operating in 5G SA mode). This will be further described below with reference to FIG. 3.

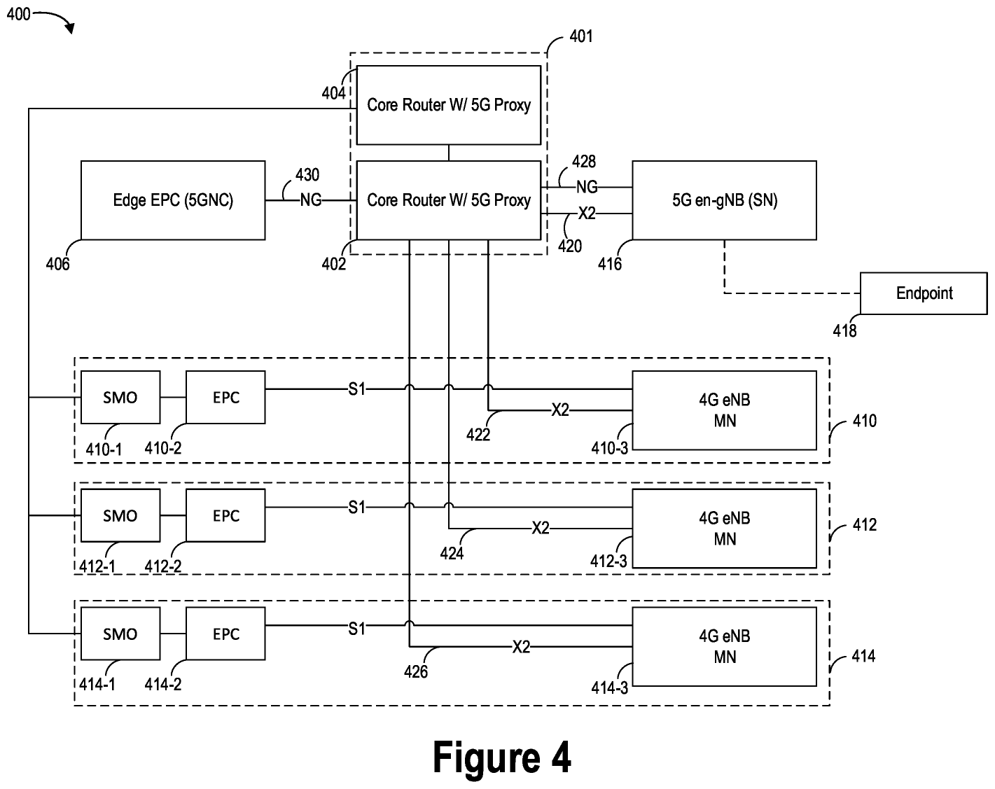

In another instance, home network of endpoint 214 (e.g., one of MNOs 102 of FIG. 1) may have a 4G/LTE core network (EPC) with endpoint 214 having dual 4G/5G radio interfaces. 5G core router 206 may provide 5G connectivity in a NSA mode of operation to endpoint 214 such that user traffic to and from endpoint 214 may be carried over the 5G radio of endpoint 214 while 5G core router may also enable communication of control signaling between endpoint 214 and its home MNO's EPC over the 4G radio interface of endpoint 214 (e.g., between e-NodeB (not shown) of the home network of endpoint 214 and endpoint 214). This communication of user traffic and control signaling may be enabled through NG and/or X2 interfaces between gNB 204, 5G core router 206 and eNodeB of the home network of endpoint 214. This will be further described below with reference to FIG. 4.

Regardless of a particular implementation of multi-purpose cellular network 110 of FIG. 1 (e.g., whether as a standalone network that may be utilized by endpoints associated with one or more MNOs and/or one or more private cellular networks as shown in FIG. 1, or as an internal component of any given MNO or private cellular network such as the configuration shown in FIG. 2), 5G core router of multi-purpose cellular network 110 enables multiple devices to simultaneously share bandwidth of the multi-purpose cellular network 110 for cellular connection and allows for multiple and simultaneous connectivity (hence scalable connectivity) between endpoints connected to multi-purpose cellular network 110 and their respective 4G/LTE and/or 5G core networks. 5G core router 122 or 5G core router 206 can function as a one-to-many gateway to multiple 5GCNs and/or as a one-to-many gateway to one or more 4G/LTE e-NodeBs and subsequently 4G/LTE EPCs. In addition and as will be described further below, 5G core router 122 and/or 5Gproxy router 206 can monitor and enforce service level agreements that are in place between MNOs and private cellular networks and operator of the multi-purpose cellular network 110 (which can be the same as the operator of one of such MNOs or private cellular networks if incorporated therein). Such agreements may be negotiated and recorded using a central management system of the multi-purpose cellular network 110.

Within example structures of a multi-purpose cellular network described above with reference to FIGS. 1 and 2, the disclosure now turns to example embodiments that illustrate the scalable (one-to-many) 5G connectivity provided by the multi-purpose cellular network and its components (e.g., 5G core router 122 of FIG. 1 and/or 5G core router 206 of FIG. 2). In addition to functionalities described below, 5G core router 122, if incorporated as part of a private cellular network, may also perform all known or to be developed functionalities of a private cellular network's edge core router such as functionalities described in U.S. application Ser. No. 16/940,739 filed on Jul. 28, 2020 and titled “SYSTEMS AND METHODS FOR MONITORING AND MANAGING NETWORK TRAFFIC IN A PRIVATE CELLULAR NETWORK”, the content of which is incorporated herein, in its entirety).

Hereinafter, example embodiments directed to 5G core router and central management functionalities of a multi-purpose cellular network will be described.

FIG. 3 is a visual representation of an architecture of a multi-purpose cellular network interconnected with multiple 5G core networks, according to an aspect of the present disclosure. More specifically, FIG. 3 provides a visual representation of various components of multi-purpose cellular network 110 of FIG. 1 and their interconnection with various other external components and networks including cloud based backend components of multi-purpose cellular network 110, a private cellular network and/or components of multiple 5G networks. Multi-purpose cellular network 110 of FIG. 1 will be referenced below when describing FIG. 3.

In environment 300 of FIG. 3, one or more endpoints 302-1, 302-2, 302-3, 302-4 and 302-5 (can collectively be referred to as endpoints 302) may be connected to one of access points 304 and 306. Endpoints 302 may be the same as endpoint 124 of FIG. 1 and/or any one of endpoints 212 and 214 of FIG. 2. For example, endpoints 302 can be any other 5G enabled devices including a mobile device with cellular connection capabilities, a tablet with cellular connection capabilities, a laptop with cellular connection capabilities, a desktop with cellular connection capabilities, a multimedia system with cellular connection capabilities, an Internet of Things (IoT) devices such as cameras, electric vehicle chargers, etc. Access points 304 and 306 may be any type of known or to be developed 5G enabled access point (e.g., a global Node-B (gNB)). Number of gNBs of multi-purpose cellular network 110 may be less (just one) or may be more (e.g., tens or hundreds of gNBs deployed at a single site or at multiple edge sites such as edge site 200 of FIG. 2).

gNBs 304 and 306 may perform Distributed Radio Network Access (D-RAN) functionalities including Remote Radio Unit (RRU) functionalities such as digital to analog signal conversion, etc. Base Band Unit (BBU) functionalities such as signal modulation/demodulation, signal coding/decoding, etc. may be performed at a centralized component 305 (e.g., in cloud based backend component 112 of FIG. 1) configured to perform Centralized RAN (C-RAN) functionalities. gNBs 304 and 306 may be installed at different locations serviced by multi-purpose cellular network 110.

In environment 300 of FIG. 3 various components that may reside at a site component 114 or at cloud based backend component 112 of multi-purpose cellular network 110 are shown as communicatively coupled together. However, such connectivity between any two components does not limit the connected components to be in a physical proximity of one another. For example, component 305 is shown as being communicatively coupled to core router 308. However, core router 308 may be deployed at a site component such as site component 114 of multi-purpose cellular network 110 while component 305 may be deployed and operate as part of cloud services 116 at cloud based backend component 112 of FIG. 1. Similarly, core router 308 and central management system 322 are shown as being communicatively coupled to and forming component 321, with core router 308 being deployed at a site component of multi-purpose cellular network 110 such as site component 114 and central management system 322 being a cloud based network service of operating as part of cloud service of multi-purpose cellular network 110 such as cloud service 116. gNBs 304, 306, and core router 308 may form a site component of multi-purpose cellular network 110 such as site component 114 of FIG. 1.

In environment 300, there may be multiple MNOs such as MNOs 314, 316 and 318. MNOs 314, 316 and 318 each of which may have one or more endpoints (e.g., one of endpoints 302) utilizing the multi-purpose cellular network by connecting to gNB 304 or gNB 306. Each of MNOs 314, 316, and 318 may have a Service Level Agreement (SLA) in effect for use of resources of multi-purpose cellular network 110 by endpoints of such MNOs. Such SLAs can define parameters, including but not limited to, Quality of Service (QoS), device types permitted to use the resources of the multi-purpose cellular network, charging/billing rate, etc. Generation, recording and implementing SLA agreements may be managed by central management system 322. Central management system 322 may be considered an autonomous trading platform for mobile network operators to offer for sale/purchase network capacity from to and from each other including network capacity of multi-purpose cellular network 110 of the present disclosure.

Each of MNOs 314, 316, and 318 may be a 5G network having a corresponding SGCN such as SGCN 314-1 for MNO 314, SGCN 316-1 for MNO 316, and SGCN 318-1 for MNO 318. Communications between C-RAN 305, and core router 308may be over a Next Generation Control/User planes (NGc/u) shown via solid connection line 319 in FIG. 3. Connections between various other components may be according to 5G air interface standards (e.g., between endpoints 302 and their respective gNB 304 or 306). Connection between gNBs 404/406 and component 305 may be according to any combination of known or to be developed open/closed interfaces that may be vendor specific.

Environment 300 further includes a Service Management and Orchestration (SMO) 320, which may be a cloud based component implemented as part of cloud services 116 of FIG. 1. SMO 320 may be configured to orchestrate and organize various SLAs for each partner network (e.g., each of MNOs 314, 316, and/or 318). As shown in FIG. 3, each MNO may have its own corresponding SMO that can be vendor specific and based on different protocols. As will be described, an SLA for each MNO may be received at central management system 322.Central management system 322 may then consolidate and generate necessary configurations for implementation of the effective SLAs. Such configurations may be generated according to any known or to be developed standard. The implementation configurations may then be passed to SMO 320. SMO 320 may then configure gNBs 304/306, component 305 and/or core router 308 for implementation, monitoring, and/or enforcing SLAs when corresponding endpoints of MNOs 314, 316, and/or 318 are connected to multi-purpose cellular network 110. While not shown in FIG. 3, private cellular network 311 may also have a corresponding SLA agreement with multi-purpose cellular network 110 and thus may include a corresponding SMO for generating and implementing such SLA.

SMO 320 may be communicatively coupled to a central management system 322, gNBs 304 and 306, C-RAN 305 and respective SMOs of each of MNOs 314, 316, and 318 (e.g., SMO 314-2 of MNO 314, SMO 316-2 of MNO 316, and SMO 318-2 of MNO 318) may be over a separate/dedicated communication lines shown as dashed-connections 324 in FIG. 3. Such connection any combination of known or to be developed open/closed interfaces that may be vendor specific.

As noted above, any one of endpoints 302 may connect to multi-purpose cellular network 110 by establishing a connection to one of gNBs 304 and 306.A connected endpoint 302 (e.g., endpoint 302-5) may be associated with a private cellular network 311 having a SGCN 310 and associated enterprise 312 shown in FIG. 3. Alternatively, private cellular network 311 may be a 4G/LTE network with core network 310 thereof being a 4G/LTE Evolved Packet Core instead of a SGCN.

For network traffic associated with connected endpoint of such private cellular network, core router 308, as described above, may route network traffic SGCN 310 (or alternatively to edge EPC of the private cellular network if the private cellular network is a 4G/LTE network) and/or ultimately to enterprise network 312. In addition to or alternative to endpoint 302-5, other endpoints 302 (e.g., endpoint 302-2, 302-3, etc.) associated with one of MNOs 314, 316, and/or 318 may also connect to multi-purpose cellular network 110. In one example, MNO 314 may be the home network of endpoint 302-2 operating on multi-purpose cellular network 110, MNO 316 may be the home network of endpoint 402-3 operating on multi-purpose cellular network 110, and MNO 316 may be home network of endpoint 402-4 operating on multi-purpose cellular network 110.

Core router 308 in conjunction with central management system 322 may configure the 5G radio network of the multi-purpose cellular network to be shared by users of MNOs 314, 316, and/or 318 that may utilize the multi-purpose cellular network by connecting to one of gNBs 304 or 306. For example, central management system 322 may coordinate with multiple MNOs 314, 316, and/or 318 to determine the services to be provided to each MNO endpoint and according to what service levels. Central management system 322 would then configure SMO 320 and core router 308 to configure the radio network of the multi-purpose cellular network 110 to use multiple spectrum bands such as C-Band and CBRS bands. As shown in FIG. 3, central management system 322 and core router 308 can split C-Band 330 into slices (e.g., three slices, each of which may be dedicated for use by connected endpoints of one of MNOs 314, 316, and 318). For example, slice 1 330-1 may be dedicated for use by connected endpoint(s) of MNO 314 (e.g., endpoint 302-2), slice 2 330-2 may be dedicated for use by connected endpoint(s) of MNO 316 (e.g., endpoint 302-3), and slice 3 330-3 may be dedicated for use by connected endpoint(s) of MNO 318 (e.g., endpoint 302-4). In conjunction with slices of C-Band, core router 308 may also split and utilize slices of radio capacity of the CBRS band 332, with each slice (e.g., one of slices 334-1, 334-2, 334-3, and/or 334-4) similarly reserved for use by connected endpoint(s) of an MNO having a corresponding SLA with the operator of the private cellular network.

Sharing of radio spectrums can be achieved in multiple ways. In one case, a common block of spectrum, such as CBRS 332, may be shared and virtual slices of capacity (e.g., slices 332-1, 332-2, 332-3, and/or 332-4) created within this shared resource. Each slice can correspond to one of the participating public or private cellular network operators. In another case, a block of spectrum, such as C-Band 330, can be sliced into subdivided blocks of spectrum and a slice (e.g., slice 1 330-1, slice 2 330-2, and/or slice 3 330-3 shown in FIG. 3) then created using the subdivided block of spectrum and reserved for the use by connected endpoints of one of the participating MNOs, private cellular networks, etc.

As noted above, SMO 320 may be configured to orchestrate and organize various SLAs for each partner network (e.g., each of private cellular network 311 and/or MNOs 314, 316, and/or 318). As shown in FIG. 3, each MNO may have its own corresponding SMO that can be vendor specific and based on different protocols. Similarly, private cellular network 311 may also a corresponding SMO (not shown). An SLA for each MNO or private cellular network may be negotiated by and received at central management system 322.Central management system 322 may then consolidate and generate necessary configurations for implementation of the effective SLAs. Such configurations may be generated according to any known or to be developed standard. The implementation configurations may then be passed to SMO 320. SMO 320 may then configure gNBs 304/306, component 305 and/or core router 308 for implementation, monitoring, and/or enforcing SLAs when corresponding endpoints of MNOs 314, 316, and/or 318 are connected to multi-purpose cellular network 110.

As part of SLA monitoring and enforcement, core router 308 can measure and record QoS of connected endpoints on multi-purpose cellular network 110 and optionally report the same to respective SMOs of private cellular network 311, MNO 314, 316, and/or 318, renegotiate terms and conditions of an in-force SLA with the corresponding MNO, etc. Such negotiation of terms and conditions can be performed automatically and recorded on a distributed ledger system on which the private cellular network and each of private cellular network 311, MNOs 314, 316 and 318 have a corresponding node. Such measuring and recording of QoS can alternatively be performed by SMO 320.

Core router 308 may have an NG interface (first interface) via which core router 308 can be communicatively coupled to gNB 304 to receive and send user and control plane traffic to and from a connected endpoint in a SA mode. Similarly, core router 308 may have a separate NG interface to a core network of each connected device (e.g., 5GCN 310 or one of 5GCNs 314-1, 316-1, and/or 318-1 of MNOs 314, 316, and 318, respectively) in order to send user and control signal traffic to the corresponding 5GCN of each connected endpoint. Accordingly, in the standalone mode and using these NG interfaces, edge core router 308 can provide a scalable many-to-one (and/or many-to-a few) connectivity to multiple 5GCNs of one or more private cellular networks and/or MNOs. Throughout the specification references may be made to various interfaces such as NG interface, X2 interface, etc., that may denote a type of connection between two endpoints according to an underlying protocol. Such interfaces may alternatively be referred to as connections (e.g., NG connection, X2 connection, etc.) throughout the specification,

As will be describe below with reference to FIG. 4, a similar scalable connectivity can be provided in a Non-Standalone mode to legacy systems such as 4G/LTE based MNOs and/or private cellular networks, when their respective endpoints connect to multi-purpose cellular network 110 and utilize cellular connectivity provided by multi-purpose cellular network 110.

FIG. 4 is a visual representation of an architecture of a multi-purpose cellular network interconnected with multiple 4G/LTE core networks, according to an aspect of the present disclosure. More specifically, FIG. 4 provides a visual representation of various components of multi-purpose cellular network 110 of FIG. 1 and their interconnection with various other external components and networks including cloud based backend components of multi-purpose cellular network 110 and/or components of multiple 4G/LTE networks. Multi-purpose cellular network 110 of FIG. 1 will be referenced below when describing FIG. 4.

In configuration 400 of FIG. 4, component 401 may be formed of core router 402 (operating at a site component of multi-purpose cellular network 110) and central management system 404 (operating at a cloud based backend component of multi-purpose cellular network 110). Component 401 may be the same as component 321 of FIG. 3. Core router 402 may also include one or more interfaces for communicating with one or more 4G/LTE networks via corresponding e-NodeBs (eNBs) of such networks, as will be described below.

5GCN 406 may be the same as edge 5GCN 310 of FIG. 3 and thus will not be further described for sake of brevity. gNB 416 may be the same as gNB 304 or gNB 306 of FIG. 3 and thus will be not be further described for sake brevity. In the context of enabling connectivity to 4G/LTE networks, gNB 416 may be referred to as a Support Node (SN) 416.

FIG. 4 shows a non-limiting example of three MNOs with 4G/LTE EPCs as MNOs 410, 412, and 414. Each MNO may include a corresponding SMO, EPC and an eNB. For example, MNO 410 includes SMO 410-1, EPC 410-2, and eNB 410-3. Similarly, MNO 412 includes SMO 412-1, EPC 412-2, and eNB 412-3 and MNO 414 includes SMO 414-1, EPC 414-2, and eNB 414-3. SMOs 410-1, 412-1, and 414-1 may be the same as SMOs 214-2, 316-2, and/or 318-2 of FIG. 3 and can perform the same functionalities for establishing, managing and monitoring SLA agreements with other network providers including multi-purpose cellular network 110 according to each network's adopted protocol.

As shown in FIG. 4, SMOs 410-1, 412-1, and 414-1 may be communicatively coupled to central management system 404 for implementing SLAs in a similar manner as described above with reference to FIG. 3. EPCs 410-2, 412-2, and 414-2 are communicatively coupled to the respective one of eNBs 410-3, 412-3, and 414-3 (e.g., via an 51 interface).

Each of eNBs 410-3, 412-3, and 414-3 may also be referred to as Master Node (MN) eNB as each may control gNB 416 to coordinate the use of gNB 416's capacity by their respective endpoints once such endpoint(s) is/are instructed to connect to gNB 416. Accordingly, each of eNBs 410-3, 412-3, and/or 414-3 may be considered a MN of gNB 416 while gNB may be considered a SN for each of eNBs 410-3, 412-3, and/or 414-3. Core router 402 allows gNB 416 to serve as a single SN for multiple eNBs (e.g., many-to-one master-slave relationship) thus providing a scalable connectivity to 5G resources of multi-purpose cellular network 110 to endpoints of multiple 4G/LTE networks in a 5G NSA mode.

For example, in the NSA mode of FIG. 4, endpoint 418 may be associated with MNO 410 and may have dual cellular connectivity using a 4G/LTE radio interface and a 5G radio interface. Endpoint 418 may monitor eNB 410-3 until endpoint 418 has user traffic to transmit/receive. When endpoint 418 has user traffic to transmit/receive, a radio schedule of eNB 410-3 would send, over X2 interface 422, a control signal to core router 402 indicating a desire for use of 5G capacity of multi-purpose cellular network 110 for transmission of user traffic to/from endpoint 418. eNB 410-3 would also instruct endpoint 418 to connect to gNB 416 using its 5G radio interface. Because the connectivity between endpoint 418 and gNB 416 is established upon a triggering event (e.g., availability of user traffic to be communicated to/from endpoint 418), the connection between endpoint 418 and gNB 416 is shown in FIG. 4 using a dashed line.

Once connected to gNB 416, endpoint 418 can send user traffic over its 5G radio to gNB 416, which gNB 416 can then send to core router 402 over NG interface 428. Core router 402 may then send the user traffic of endpoint 418 to eNB 410-3 over X2 interface 422, which eNB 410-3 may then route to EPC 410-2 of MNO 410. Furthermore, control signals for endpoint 418 may be exchanged between eNB 410-3, core router 402 and gNB 416 using X2 interfaces 420 and 422. For example, when eNB 410-3 directs endpoint 418 to connect to gNB 416, eNB 410-3 may send necessary control signals to core router 402 over X2 interface 422 to schedule resources of multi-purpose cellular network 110 for use by endpoint 418. Furthermore, any controls signals destined for endpoint 418 may be sent from eNB 410-3 to core router 402 over X2 interface 422 and then between core router 402 and gNB 416 over X2 interface 420. Ultimately, gNB 426 may transmit such control signals to endpoint 418 (e.g., over endpoint 418′s 4G radio interface). Similarly, any control signals from endpoint 418 and destined for eNB 410-3 may be sent from endpoint 418 to gNB 416 (e.g., over endpoint 418's 4G radio interface), which gNB 416 may then route to core router 402 over X2 interface 420 for core router 402 to then route the control signal to eNB 410-3 over X2 interface 422.

FIG. 4 further illustrates X2 interfaces 424 and 426 to eNBs 412-3 and 414-3 to allow for the same connectivity of respective users of MNOs 412 and 414 to multi-purpose network 110, as described above with reference to endpoint 418 and eNB 410-3 of MNO 410.

In another example, an endpoint of a private cellular network may utilize multi-purpose cellular network 110. If private cellular network is a 5G network, then both user and control traffic may be communicated between the endpoint, gNB 41, core router 402 and 5GCN 406 over NG connections 428 and 430. If such private cellular network is a 4G/LTE network and the corresponding endpoint has 4G/LTE and 5G connectivity interfaces, then routing of user and control traffic between the endpoint and the 4G/LTE EPC (5GCN 406 may be replaced with 4G/LTE EPC 406 in FIG. 4) of the private cellular network may be performed in the same manner as described above with reference to endpoint 418 and eNB 410-3. In example of a 4G/LTE private cellular network, there may be another MN eNB between core router 402 and 4G/LTE EPC of the private cellular network (not shown in FIG. 4).

In addition to enabling simultaneous and scalable connectivity to multiple 4G/LTE MNOs, core router 402, in coordination with central management system 404, may monitor and enforce effective SLAs between operator of multi-purpose cellular network 110 and respective MNOs of endpoints connected to multi-purpose cellular network. As part of enforcing an active SLA, core router 402 may also perform 5G spectrum sharing among connected endpoints to ensure adherence to any agreed upon bandwidth, data rate, QoS, etc., as specified for each connected endpoint in their respective SLA.

Accordingly, core router 308 and central management system 322 of FIG. 3 or core router 402 and central management system 404 of FIG. 4 may function in concert to provide the scalable 5G connectivity in SA and NSA modes as described above. In one example, central management system 322 of FIG. 3 may operate in non-real time or real-time to generate and record SLA agreements with multiple cellular network operators (both private and MNOs) while core router 308 of FIG. 3 may operate in real-time to enable 5G spectrum sharing among connected endpoints, establish connections to multiple 4G/LTE core networks, and/or monitor and enforce SLA agreements provided by central management system 322. Similarly, central management system 404 of FIG. 4 may operate in non-real time or real-time to generate and record SLA agreements with multiple cellular network operators (both private and MNOs) while core router 402 of FIG. 4 may operate in real-time to enable 5G spectrum sharing among connected endpoints, establish connections to multiple 4G/LTE core networks, and/or monitor and enforce SLA agreements provided by central management system 404.

While a number of components of multi-purpose cellular network 110, a private cellular network and/or 4G/LTE or 5G MNOs are shown in FIGS. 3 and 4, components of these networks are not limited to those shown in FIGS. 3 and 4 but may include any additional known or to be developed component or functionality for proper operation of these networks.

Furthermore, while FIGS. 3 and 4 each illustrate a separate example of interconnectivity between a multi-purpose cellular network, a private cellular network, and multiple 5G MNOs (FIG. 3) or multiple 4G/LTE MNOs (FIG. 4), the present disclosure is not limited thereto. While not shown, multi-purpose cellular network of the present disclosure can also include examples where multi-purpose cellular network 110 is simultaneously accessed/shared by (1) one or more 5G private cellular networks, (2) one or more 4G/LTE private cellular networks, (3) one or more 5G MNOs, and/or (4) one or more 4G/LTE MNOs. Furthermore, while such multi-purpose cellular network is described as a fully integrated and independent cellular network accessed by such private cellular networks and/or MNOs, the present disclosure is not limited thereto and also covers examples where multi-purpose cellular network 110 is a permanent structure of any given private cellular network or MNO network and can provide same functionalities as described above when accessed by endpoints connected to such private cellular network/MNO network.

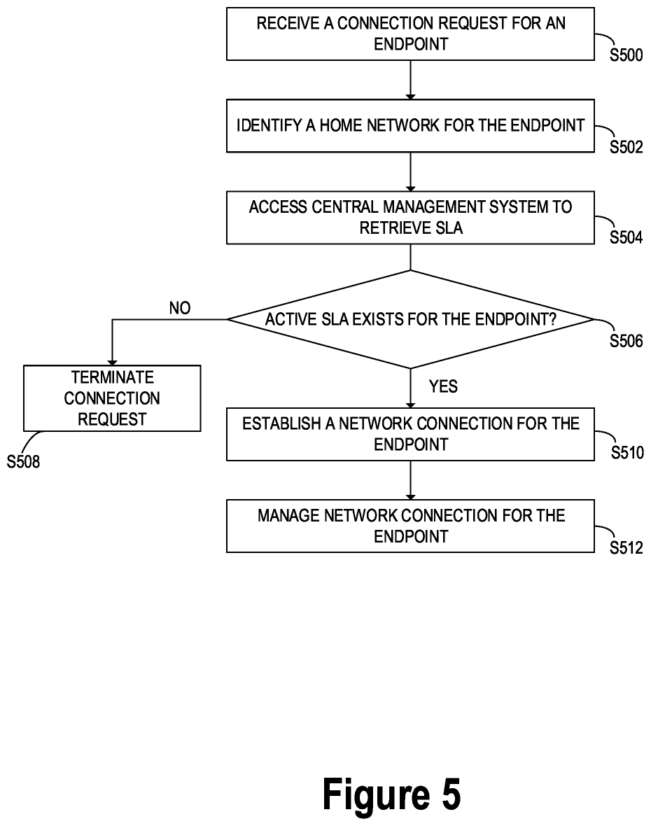

FIG. 5 is a flowchart of a method of operation of core router of multi-purpose cellular network of FIGS. 3 and 4, according to an aspect of the present disclosure. Those skilled in the art would readily understand and appreciate that a core router such as core router 308 of FIG. 3 or core router 402 of FIG. 4 may have one or more memories with computer-readable instructions stored therein that can be executed by one or more associated processors to perform functionalities and steps described below with reference to FIG. 5. For sake of brevity, FIG. 5 will be described from the perspective of core router 308 of FIG. 3 but can equally be performed from the perspective of core router 402 of FIG. 4. Furthermore, an assumption is made that a combination of MNOs with 4G/LTE core networks and MNOs with 5G core networks have active SLAs with multi-purpose cellular network 110 for operation of their endpoints on multi-purpose cellular network 110. In describing FIG. 5, references may be made to FIGS. 3 and 4.

At S500, core router 308 may receive a request connection to multi-purpose cellular network 110. As described with reference to FIG. 3, when an endpoint connected to multi-purpose cellular 110 is a 5G endpoint associated with a 5G MNO, such request for connection may be received from the endpoint (e.g., endpoint 302-1) when endpoint 302-1 attempts to connect to multi-purpose cellular network 110. However, if the endpoint is associated with a MNO having a 4G/LTE core network and a corresponding eNB (e.g., endpoint 418 associated with MNO 410 and corresponding eNB 410-3 in FIG. 4), such connection request may be received from eNB 410-3 when there is data to be exchanged with endpoint 418. In this case, eNB 410-3 sends a command to endpoint 418 to connect to gNB 413 and sends a control signal to core router 308 (or core router 402) to coordinate use of 5G network capacity of multi-purpose cellular network 110 by endpoint 418, as described above with reference to FIG. 4.

At S502, core router 308 may identify a home network of the endpoint for which a connection request is received at S500. This identification may be based on device identifier of the endpoint from which a connection request is received and/or may be based on an identifier included in a control signal received from an eNB such as eNB 410-3, as described above.

At S504, core router 308 may access central management system 322 to determine whether an active SLA that permits an endpoint access to multi-purpose cellular network 110 exists in association with the endpoint for which connection request is received at S500.

At S506, core router 308 may determine whether an active SLA is in place for the endpoint for which a connection request is received at S500. In one example, core router 308 may communicate with central management system 322 and based on the information retrieved from the central management system 322, determine whether an active SLA is in place for the endpoint. If no active SLA exists for the endpoint, then the connection request is denied at S508.

However, if an active SLA exists, then at S510, core router 308 may establish a network connection for the endpoint for which a connection request is received at S500. In instances where the endpoint is a 5G endpoint having a corresponding 5G home network with a 5GCN (in the SA mode), a connection may established be over 5G NG interfaces (e.g., a first NG interface between core router 308 and gNB 304 or 306 and a second NG interface between core router 308 and a corresponding 5GCN of the connected device, which can be any one of 5GCNs 310, 314-1, 316-1, and/or 318-1) for both user and control traffic, as described above with reference to FIG. 3. In instances where the endpoint is a 4G/5G endpoint (having 4G/LTE and 5G radio interfaces) with a corresponding 4G/LTE home network having a 4G/LTE EPC (in the NSA mode), a connection may be established with user traffic exchanged over a 5G NG interface for user traffic (first interface such as NG interface 428 of FIGS. 4) and 4G/LTE X2 interfaces (second interface such as X2 interfaces 420 and 422 of FIG. 4) for control signaling as described above with reference to FIG. 4. Moreover, core router 308 may determine the endpoint's access to the private cellular network based on the active SLA (using a third interface between central management system 322 and SMOs of external MNOs/private cellular networks). Such determination includes, but is not limited to, a slice of the 5G radio band (e.g., C-Band 330, CBRS 332, etc.) accessible to the endpoint, establishes appropriate connection to and routing network traffic to the home core network of the connected endpoint (in SA or NSA modes as described above with reference to FIGS. 3 and 4), etc.

At S512 and for each endpoint connected to the multi-purpose cellular network 110, core router 308 may monitor and enforce the corresponding SLA agreement, may measure Key Performance Indications (KPIs) such as QoS, data download/upload rate, packet drop rate, etc. As noted above, core router 308 may report such measurements to SMO 320 or alternatively, directly to home SMO at the home network of the endpoint (e.g., one of SMOs 314-2, 316-2, 318-2).

In one example, such report on monitored SLA or measured KPIs for a endpoint connected to the private cellular network may be communicated to SMO 320 or the corresponding home SMO of the endpoint on a continuous basis (e.g., while the endpoint is actively connected to multi-purpose cellular network 110), and/or alternatively may be communicated after the connection of the endpoint on multi-purpose cellular network 110 ends.

With various examples of traffic management and routing at a core router of a private enterprise network deployed at a site described above, the disclosure now turns to description of several example system components and architectures that can be utilized to function as any one or more components of ecosystems described above such as core router 308, central management system 322 and/or any other component of network architecture described above with reference to FIGS. 1-5 for enabling the scalable 5G connectivity to multiple endpoints of multiple MNOs/private cellular networks.

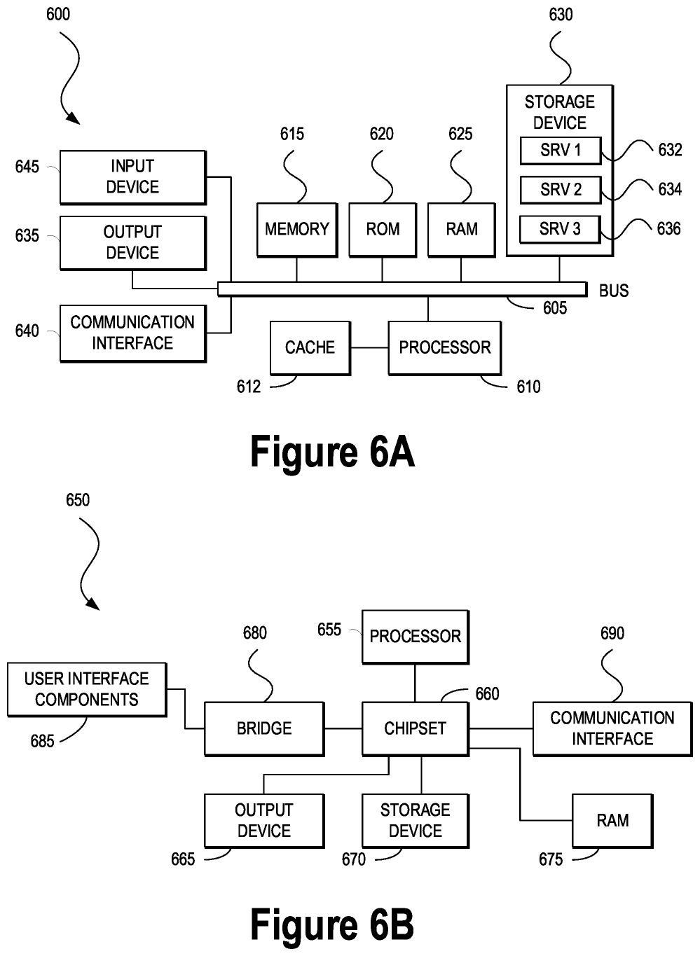

FIGS. 6A and 6B illustrate systems, according to an aspect of the present disclosure. The more appropriate system will be apparent to those of ordinary skill in the art when practicing the various embodiments. Persons of ordinary skill in the art will also readily appreciate that other systems are possible.

FIG. 6A illustrates an example of a bus computing system 600 wherein the components of the system are in electrical communication with each other using a bus 605. The computing system 600 can include a processing unit (CPU or processor) 610 and a system bus 605 that may couple various system components including the system memory 615, such as read only memory (ROM) 620 and random access memory (RAM) 625, to the processor 610. The computing system 600 can include a cache 612 of high-speed memory connected directly with, in close proximity to, or integrated as part of the processor 610. The computing system 600 can copy data from the memory 615, ROM 620, RAM 625, and/or storage device 630 to the cache 612 for quick access by the processor 610. In this way, the cache 612 can provide a performance boost that avoids processor delays while waiting for data. These and other modules can control the processor 610 to perform various actions. Other system memory 615 may be available for use as well. The memory 615 can include multiple different types of memory with different performance characteristics. The processor 610 can include any general purpose processor and a hardware module or software module, such as services (SVC) 1 632, SVC 2 634, and SVC 3 636 stored in the storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing system 600, an input device 645 can represent any number of input mechanisms, such as a microphone for speech, a touch-protected screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing system 600. The communications interface 640 can govern and manage the user input and system output. There may be no restriction on operating on any particular hardware arrangement and therefore the basic features here may easily be substituted for improved hardware or firmware arrangements as they are developed.

The storage device 630 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof

As discussed above, the storage device 630 can include the software SVCs 632, 634, and 636 for controlling the processor 610. Other hardware or software modules are contemplated. The storage device 630 can be connected to the system bus 605. In some embodiments, a hardware module that performs a particular function can include a software component stored in a computer-readable medium in connection with the necessary hardware components, such as the processor 610, bus 605, output device 635, and so forth, to carry out the function.

FIG. 6B illustrates an example architecture for a chipset computing system 650 that can be used in accordance with an embodiment. The computing system 650 can include a processor 655, representative of any number of physically and/or logically distinct resources capable of executing software, firmware, and hardware configured to perform identified computations. The processor 655 can communicate with a chipset 660 that can control input to and output from the processor 655. In this example, the chipset 660 can output information to an output device 665, such as a display, and can read and write information to storage device 670, which can include magnetic media, solid state media, and other suitable storage media. The chipset 660 can also read data from and write data to RAM 675. A bridge 680 for interfacing with a variety of user interface components 685 can be provided for interfacing with the chipset 660. The user interface components 685 can include a keyboard, a microphone, touch detection and processing circuitry, a pointing device, such as a mouse, and so on. Inputs to the computing system 650 can come from any of a variety of sources, machine generated and/or human generated.

The chipset 660 can also interface with one or more communication interfaces 690 that can have different physical interfaces. The communication interfaces 690 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 655 analyzing data stored in the storage device 670 or the RAM 675. Further, the computing system 650 can receive inputs from a user via the user interface components 685 and execute appropriate functions, such as browsing functions by interpreting these inputs using the processor 655.

It will be appreciated that computing systems 600 and 650 can have more than one processor 610 and 655, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some example embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A management system of a multi-purpose cellular network comprising:
a first interface configured to communicatively couple with at least one fifth-generation (5G) base station of the multi-purpose cellular network;
a second interface configured to communicatively couple with at least one fourth-generation (4G) base station of at least one external network operator;
a third interface configured to communicatively couple with the at least one external network operator;
at least one memory having computer-readable instructions stored therein; and
one or more processors configured to execute the computer-readable instructions to:
receive a connection request for an endpoint to connect to the multi-purpose cellular network, the endpoint being associated with one of the at least one external network operator, wherein a core network of each external network operator is one of a fourth generation (4G) core network or a fifth generation (5G) core network;
establish a network connection for the endpoint to operate on the multi-purpose cellular network based on a service level agreement between a corresponding external network operator of the endpoint and the multi-purpose cellular network obtained via the third interface; and
manage the network connection for the endpoint, wherein managing the network connection includes routing network traffic for the endpoint, to:
a 4G core network of the corresponding external network operator via the first interface for user traffic and via the second interface for control signals, if the core network of the corresponding external network is a 4G core network; or
a 5G core network of the corresponding external network operator via the first interface, if the core network of the corresponding external network is a 5G core network.

2. The management system of claim 1, wherein the first interface is a New Generation (NG) interface.

3. The management system of claim 1, wherein the second interface is an X2 interface.

4. The management system of claim 1, wherein the management system comprises a core router including the first interface and the second interface, the core router being installed at a site component of the multi-purpose cellular network.

5. The management system of claim 4, wherein the core router is configured to simultaneously manage spectrum sharing of a plurality of endpoints on the multi-purpose cellular network according to respective service level agreements for each of the plurality of endpoints and establish communicating to respective core networks of the plurality of endpoints for transmission of user traffic and control signal using at least one of the first interface and the second interface, at least one core network of the core networks being the 4G core network and at least one core network of the core networks being a 5G core network.

6. The management system of claim 1, wherein the management system comprises a cloud based component comprising the third interface that is communicatively coupled to a service management and orchestration component of the corresponding external network operator of the endpoint to generate, record and implement the service level agreement.

7. The management system of claim 1, wherein the at least one external network operator is an operator of a private cellular network having the 4G core network or the 5G core network, or an operator of a public mobile network having the 4G core network or the 5G core network.

8. The management system of claim 1, wherein the one or more processors are configured to execute the computer-readable instructions to configure a radio access network of the multi-purpose cellular network to be shared by a plurality of endpoints by partitioning a spectrum of the radio access network into virtual slices, each virtual slice of the virtual slices being assigned to one of the plurality of endpoints.

9. The management system of claim 1, wherein the service level agreement indicates a level of wireless connectivity available to the endpoint when connected to the multi-purpose cellular network.

10. The management system of claim 1, wherein managing the network connection is further includes measuring Key Performance Indicators (KPIs) associated with operation of the endpoint on the multi-purpose cellular network, the KPIs including at least one of a Quality of Service (QoS) of a connection between the endpoint and the multi-purpose cellular network, data download/upload rate, and packet drop rate.

11. One or more non-transitory computer-readable media comprising computer-readable instructions, which when executed by one or more processors of a management system of a multi-purpose cellular network, cause the management system to:
receive a connection request for an endpoint to connect to the multi-purpose cellular network, the endpoint being associated with at least one external network operator, wherein a core network of the external network operator associated with the endpoint is one of a fourth generation (4G) core network or a fifth generation (5G) core network, the management system including a first interface configured to communicatively couple with at least one fifth-generation (5G) base station of the multi-purpose cellular network, a second interface configured to communicatively couple with at least one fourth-generation (4G) base station of the at least one external network operator, and a third interface configured to communicatively couple with the at least one external network operator;
establish a network connection for the endpoint to operate on the multi-purpose cellular network based on a service level agreement between a corresponding external network operator of the endpoint and the multi-purpose cellular network obtained via the third interface; and
manage the network connection for the endpoint, wherein managing the network connection includes at least routing network traffic for the endpoint to:
a 4G core network of the corresponding external network operator via the first interface for user traffic and via the second interface for control signals, if the core network of the corresponding external network is a 4G core network; or
a 5G core network of the corresponding external network operator via the first interface, if the core network of the corresponding external network is a 5G core network.

12. The one or more non-transitory computer-readable media of claim 11, wherein the first interface is a New Generation (NG) interface.

13. The one or more non-transitory computer-readable media of claim 11, wherein the second interface is an X2 interface.

14. The one or more non-transitory computer-readable media of claim 11, wherein the management system comprises a core router including the first interface and the second interface, the core router being installed at a site component of the multi-purpose cellular network.

15. The one or more non-transitory computer-readable media of claim 14, wherein the core router is configured to simultaneously manage spectrum sharing of a plurality of endpoints on the multi-purpose cellular network according to respective service level agreements for each of the plurality of endpoints and establish communicating to respective core networks of the plurality of endpoints for transmission of user traffic and control signal using at least one of the first interface and the second interface, at least one core network of the core networks being the 4G core network and at least one core network of the core networks being a 5G core network.

16. The one or more non-transitory computer-readable media of claim 11, wherein the management system comprises a cloud based component comprising the third interface that is communicatively coupled to a service management and orchestration component of the corresponding external network operator of the endpoint to generate, record and implement the service level agreement.

17. The one or more non-transitory computer-readable media of claim 11, wherein the at least one external network operator is an operator of a private cellular network having the 4G core network or the 5G core network, or an operator of a public mobile network having the 4G core network or the 5G core network.

18. The one or more non-transitory computer-readable media of claim 11, the execution of the computer-readable instructions by the one or more processors, cause the management system to configure a radio access network of the multi-purpose cellular network to be shared by a plurality of endpoints by partitioning a spectrum of the radio access network into virtual slices, each virtual slice of the virtual slices being assigned to one of the plurality of endpoints.

19. The one or more non-transitory computer-readable media of claim 11, wherein the service level agreement indicates a level of wireless connectivity available to the endpoint when connected to the multi-purpose cellular network.

20. The one or more non-transitory computer-readable media of claim 11, wherein managing the network connection is further includes measuring Key Performance Indicators (KPIs) associated with operation of the endpoint on the multi-purpose cellular network, the KPIs including at least one of a Quality of Service (QoS) of a connection between the endpoint and the multi-purpose cellular network, data download/upload rate, and packet drop rate.
